(19) United States
(12) Patent Application Publication
(10) Pub. No.: US 2025/0282317 A1
(43) Pub. Date: Sep. 11, 2025

(54) VEHICLE OCCUPANT RESTRAINT DEVICE

(71) Applicant: TOYOTA JIDOSHA KABUSHIKI KAISHA, Toyota-shi Aichi-ken (JP)

(72) Inventors: Katsuya SHIMAZU, Toyota-shi Aichi-ken (JP); Daiki FURUKAWA, Toyota-shi Aichi-ken (JP); Mitsuyoshi OHNO, Miyoshi-shi Aichi-ken (JP); Kaname TANAKA, Toyota-shi Aichi-ken (JP)

(73) Assignee: TOYOTA JIDOSHA KABUSHIKI KAISHA, Toyota-shi Aichi-ken (JP)

(21) Appl. No.: 19/039,359

(22) Filed: Jan. 28, 2025

(30) Foreign Application Priority Data
Mar. 6, 2024 (JP) 2024-034380

(51) Int. Cl. B60R 21/18; B60R 21/207; B60R 21/217

(52) U.S. Cl. CPC B60R 21/18; B60R 21/207; B60R 21/217

(57) ABSTRACT

A vehicle occupant restraint device includes: a seat belt configured to restrain an occupant to the vehicle seat; a belt support airbag configured to inflate and deploy at least between a shoulder belt and a shoulder of the occupant by being supplied with gas from an inflator in an event of a frontal collision of a vehicle, to move toward a front side of the vehicle following the occupant, who moves toward the front side of the vehicle, and to restrain at least the shoulder of the occupant; and a gas supply pipe having a first end portion connected to the inflator, a second end portion connected to the belt support airbag, and a predetermined region on a second end portion side, the predetermined region being configured to extend following the movement of the belt support airbag toward the front side of the vehicle.

### CROSS-REFERENCE TO RELATED APPLICATION

This application claims priority to Japanese Patent Application No. 2024-034380 filed on Mar. 6, 2024. The disclosure of the above-identified application, including the specification, drawings, and claims, is incorporated by reference herein in its entirety.

### BACKGROUND

### 1. Technical Field

The present disclosure relates to a vehicle occupant restraint device.

### 2. Description of Related Art

An occupant protection device that suppresses a sudden increase in a restraint force on a head of an occupant in an event of a frontal collision of a vehicle is known in the related art (for example, refer to Japanese Unexamined Patent Application Publication No. 2017-124759 (JP 2017-124759 A)). The occupant protection device includes an airbag and a connecting fabric. The airbag deploys in a region including a front side and both right and left sides of the head of the occupant to cover the head. The connecting fabric has an elongation rate equal to or less than that of the airbag. A first end portion of the connecting fabric is connected to a front portion of the airbag, and a second end portion of the connecting fabric is connected to a force limiter mechanism provided inside a headrest.

### SUMMARY

However, in the occupant protection device as described above, a momentum of the airbag that is to deploy forward is supported and controlled by the force limiter mechanism provided inside the headrest, so that a complicated mechanism is needed inside the headrest. As described above, there is still room for improvement in that the occupant can be effectively restrained without providing a complicated mechanism in an event of a frontal collision of the vehicle.

The present disclosure provides a vehicle occupant restraint device capable of effectively restraining an occupant in an event of a frontal collision of a vehicle, even with a simple configuration.

A first aspect of the disclosure relates to a vehicle occupant restraint device including a seat belt, a belt support airbag, and a gas supply pipe. The seat belt is configured to restrain an occupant seated on a vehicle seat to the vehicle seat. The belt support airbag is configured to inflate and deploy at least between a shoulder belt in the seat belt and a shoulder of the occupant by being supplied with gas from an inflator in an event of a frontal collision of a vehicle, to move toward a front side of the vehicle following the occupant P, who moves toward the front side of the vehicle due to an inertial force, and to restrain at least the shoulder of the occupant. The gas supply pipe has a first end portion connected to the inflator and a second end portion connected to the belt support airbag. A predetermined region of the gas supply pipe on a second end portion side is configured to extend following the movement of the belt support airbag toward the front side of the vehicle.

According to the disclosure of the first aspect, the belt support airbag inflates and deploys at least between the shoulder belt in the seat belt and the shoulder of the occupant by being supplied with the gas from the inflator in an event of a frontal collision of a vehicle, moves toward the front side of the vehicle following the occupant, who moves toward the front side of the vehicle due to the inertial force, and restrains at least the shoulder of the occupant. That is, the shoulder belt in the seat belt serves as a member that receives a reaction force of the belt support airbag. In this case, the predetermined region of the gas supply pipe on the second end portion side of the gas supply pipe, which has the first end portion connected to the inflator and the second end portion connected to the belt support airbag, extends following the movement of the belt support airbag toward the front side of the vehicle.

Therefore, regardless of a physique of the occupant, the belt support airbag can be continuously held at least between the shoulder belt and the shoulder of the occupant, and at least the shoulder of the occupant can be effectively restrained from a first half to a second half of the occupant restraint, while the occurrence of a problem, such as breakage of the gas supply pipe, can be suppressed or prevented. Further, the inflated and deployed belt support airbag forms a predetermined gap between the shoulder belt and a chest of the occupant.

As described above, according to the aspect of the disclosure, even with a simple configuration in which the predetermined region of the gas supply pipe on the second end portion side connected to the belt support airbag of the gas supply pipe is extendable, the occupant is efficiently restrained in an event of a frontal collision of the vehicle. The phrase “in an event of a frontal collision” of the vehicle mentioned here includes a time when a frontal collision of the vehicle is predicted (forecasted) to be unavoidable.

The vehicle occupant restraint device may further include a cover member. A bellows-shaped expandable portion is provided in the predetermined region of the gas supply pipe. The expandable portion of the gas supply pipe and the belt support airbag that is folded are accommodated in the cover member.

In the configuration, the predetermined region of the gas supply pipe on the second end portion side connected to the belt support airbag serves as the bellows-shaped expandable portion, and the expandable portion of the gas supply pipe and the folded belt support airbag are accommodated in the cover member. That is, the expandable portion and the belt support airbag are provided outside the vehicle seat. Therefore, it is not necessary to provide a complicated structure inside the vehicle seat. Furthermore, since the expandable portion and the belt support airbag are hidden by the cover member, an appearance of the vehicle seat is suppressed from being damaged.

The bellows-shaped expandable portion may be configured to be shortened when the bellows-shaped expandable portion is accommodated in the cover member. The bellows-shaped expandable portion may be configured to extend and expand to a predetermined outer diameter when the belt support airbag inflates and deploys. The bellows-shaped expandable portion may be configured to further extend and contract to a predetermined inner diameter when the belt support airbag moves toward the front side of the vehicle.

With this configuration, the bellows-shaped expandable portion is shortened when the expandable portion is accommodated in the cover member. Therefore, an accommodating space is reduced in size, and accommodation performance is improved. Additionally, when the belt support airbag inflates and deploys, the bellows-shaped expandable portion extends and expands to a predetermined outer diameter. Therefore, the gas is supplied to the belt support airbag quickly, sufficiently, and stably. Furthermore, regarding the bellows-shaped expandable portion, when the belt support airbag moves toward the front side of the vehicle, the bellows-shaped expandable portion further extends and contracts to a predetermined inner diameter. Therefore, the gas supplied to the belt support airbag is less likely to return to an inflator side.

The expandable portion of the gas supply pipe may be provided with a stent member that restricts excessive expansion.

With this configuration, the expandable portion of the gas supply pipe is provided with the stent member that restricts excessive expansion. Therefore, a decrease in gas supply capacity (gas pressure) due to the excessive expansion of the expandable portion of the gas supply pipe can be suppressed.

Additionally, the expandable portion of the gas supply pipe may be formed in a crushed shape along the shoulder belt when the expandable portion is accommodated in the cover member.

With this configuration, the expandable portion of the gas supply pipe is formed in a crushed shape along the shoulder belt when the expandable portion is accommodated in the cover member. Therefore, the expandable portion of the gas supply pipe can be utilized as a cushion member, so that wearability of a shoulder belt part when the seat belt is worn can be improved.

The shoulder belt may be movably inserted through a guide member accommodated in the cover member and may not be in contact with the expandable portion of the gas supply pipe.

With this configuration, the shoulder belt is movably inserted through the guide member accommodated in the cover member and is not in contact with the expandable portion of the gas supply pipe. Therefore, when the seat belt is fastened or detached, an external force, such as a tensile load, is not applied to the expandable portion of the gas supply pipe, and the seat belt can be smoothly moved.

A force limiter mechanism may be provided in a retractor that winds the seat belt. The expandable portion of the gas supply pipe may be configured to extend under a load lower than a force limiter load of the force limiter mechanism.

With this configuration, the force limiter mechanism is provided in the retractor that winds the seat belt. The expandable portion of the gas supply pipe extends under a load lower than the force limiter load of the force limiter mechanism. Therefore, the occurrence of a problem in which the gas supply pipe interferes with an operation of the force limiter mechanism can be suppressed or prevented. As a result, a behavior of the occupant can be easily controlled.

The inflator may be embedded in a seat back of the vehicle seat together with the retractor.

With this configuration, the inflator is embedded in the seat back of the vehicle seat together with the retractor. Therefore, installation of each of the components constituting the vehicle occupant restraint device can be completed solely by the vehicle seat including the seat belt and the like, and workability during assembly of the vehicle is improved.

A bellows-shaped expandable portion may be provided in the predetermined region of the gas supply pipe. The expandable portion may be provided between the seat back and the belt support airbag.

As described above, the vehicle occupant restraint device according to the aspect of the present disclosure can effectively restrain the occupant in an event of a frontal collision of the vehicle, even with a simple configuration.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view showing a state when a belt support airbag of a vehicle occupant restraint device according to a first embodiment inflates and deploys;

FIG. 2 is a schematic front view showing the state when the belt support airbag of the vehicle occupant restraint device according to the first embodiment inflates and deploys;

FIG. 3 is a schematic side view showing the state when the belt support airbag of the vehicle occupant restraint device according to the first embodiment inflates and deploys;

FIG. 4 is a schematic front view showing a normal state of the belt support airbag of the vehicle occupant restraint device according to the first embodiment;

FIG. 5 is a schematic side view showing the normal state of the belt support airbag of the vehicle occupant restraint device according to the first embodiment;

FIG. 6 is a schematic side sectional view showing an internal structure of the belt support airbag of the vehicle occupant restraint device according to the first embodiment when the belt support airbag is inflated and deployed;

FIG. 7 is a schematic partially enlarged sectional view showing a structure of a gas supply pipe of the vehicle occupant restraint device according to the first embodiment;

FIG. 8A is a schematic cross-sectional view showing a state when the gas supply pipe of the vehicle occupant restraint device according to the first embodiment expands in diameter;

FIG. 8B is a schematic cross-sectional view showing a state when the gas supply pipe of the vehicle occupant restraint device according to the first embodiment contracts in diameter;

FIG. 9A is a schematic side view showing a state before a gas supply pipe of a vehicle occupant restraint device according to a modification example of the first embodiment extends;

FIG. 9B is a schematic side view showing a state while the gas supply pipe of the vehicle occupant restraint device according to the modification example of the first embodiment extends;

FIG. 9C is a schematic side view showing a state after the gas supply pipe of the vehicle occupant restraint device according to the modification example of the first embodiment extends;

FIG. 10 is a schematic enlarged sectional view showing a normal state of the gas supply pipe of the vehicle occupant restraint device according to the modification example of the first embodiment;

FIG. 11A is a schematic side view showing a state before the belt support airbag of the vehicle occupant restraint device according to the first embodiment inflates and deploys;

FIG. 11B is a schematic side view showing a state while the belt support airbag of the vehicle occupant restraint device according to the first embodiment inflates and deploys;

FIG. 12A is a schematic side view showing a state immediately after the inflation and deployment of the belt support airbag of the vehicle occupant restraint device according to the first embodiment is completed;

FIG. 12B is a schematic side view showing a state in which the belt support airbag of the vehicle occupant restraint device according to the first embodiment moves forward;

FIG. 13 is a schematic perspective view showing a state when a belt support airbag of a vehicle occupant restraint device according to a second embodiment inflates and deploys;

FIG. 14 is a schematic front view showing the state when the belt support airbag of the vehicle occupant restraint device according to the second embodiment inflates and deploys; and

FIG. 15 is a schematic side view showing the state when the belt support airbag of the vehicle occupant restraint device according to the second embodiment inflates and deploys.

### DETAILED DESCRIPTION OF EMBODIMENTS

Hereinafter, embodiments of the present disclosure will be described in detail with reference to the drawings. For convenience of description, regarding arrows appropriately shown in each of the drawings, an arrow UP indicates an upward direction of a vehicle and a vehicle seat, an arrow FR indicates a forward direction of the vehicle and the vehicle seat, and an arrow RH indicates a rightward direction of the vehicle and the vehicle seat. Therefore, in the following description, in a case where up-down, front-rear, and right-left directions are described without particular mention, up-down, front-rear, and right-left directions in the vehicle and the vehicle seat are represented. In addition, the right-left direction is the same as a vehicle width direction and a seat width direction.

### First Embodiment

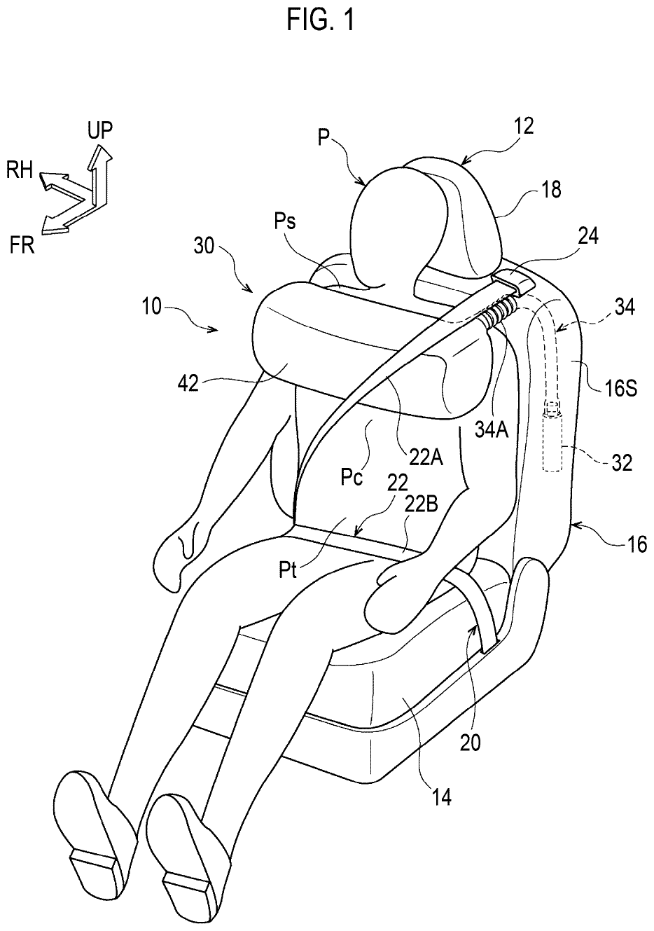

First, a first embodiment will be described. As shown in FIGS. 1 to 5, a vehicle occupant restraint device 10 according to the first embodiment is provided on a vehicle seat 12. The vehicle seat 12 is a front seat or a rear seat of a vehicle (automobile), and here, the front seat is the vehicle seat 12. The vehicle seat 12 includes a seat cushion 14, a seat back 16 that is provided to be rotatable about a seat width direction as an axial direction at a rear end portion of the seat cushion 14, and a headrest 18 that is provided to be movable up and down at an upper end portion of the seat back 16.

In FIG. 1 and the like, a collision test dummy (human body dummy) is shown seated on the seat cushion 14 of the vehicle seat 12 as a model of an occupant (seated person) to be protected. The dummy is, for example, an AM50 (50th percentile of US adult male) dummy (Hybrid III) for frontal collision tests. The dummy is seated in a standard sitting posture determined by a collision test method, and the vehicle seat 12 is positioned at a reference set position corresponding to the sitting posture. The dummy is hereinafter referred to as an “occupant P”.

As shown in FIGS. 1 to 5, the occupant P seated on the seat cushion 14 of the vehicle seat 12 is restrained to the vehicle seat 12 by a seat belt (webbing) 22 provided in a seat belt device 20. The seat belt device 20 is a three-point seat belt device, and is a so-called seat-integrated seat belt device. In addition, in the following description, a part of the seat belt 22 that is stretched from a shoulder Ps to an abdomen Pt of the occupant P is referred to as a shoulder belt 22A. The seat belt 22 also includes a lap belt 22B.

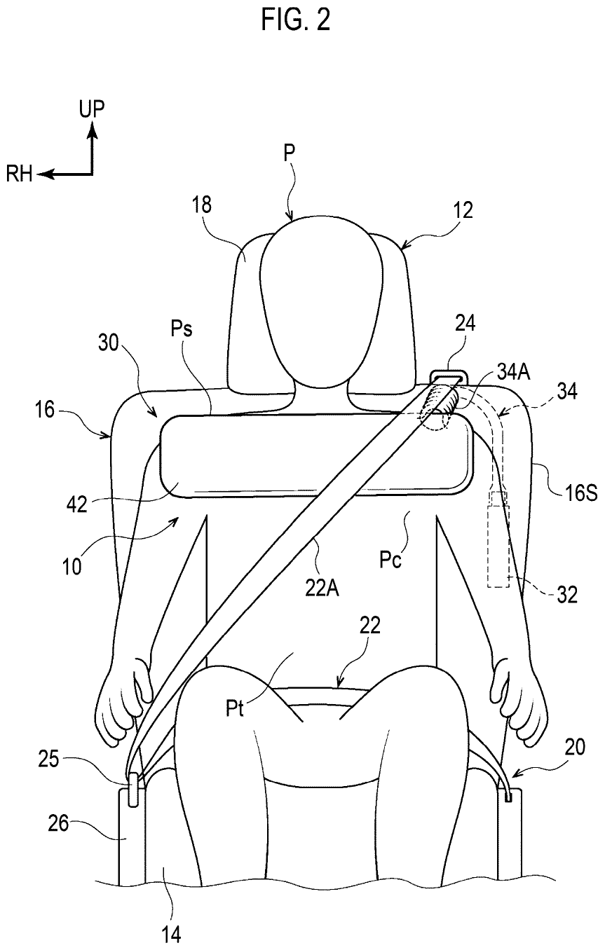

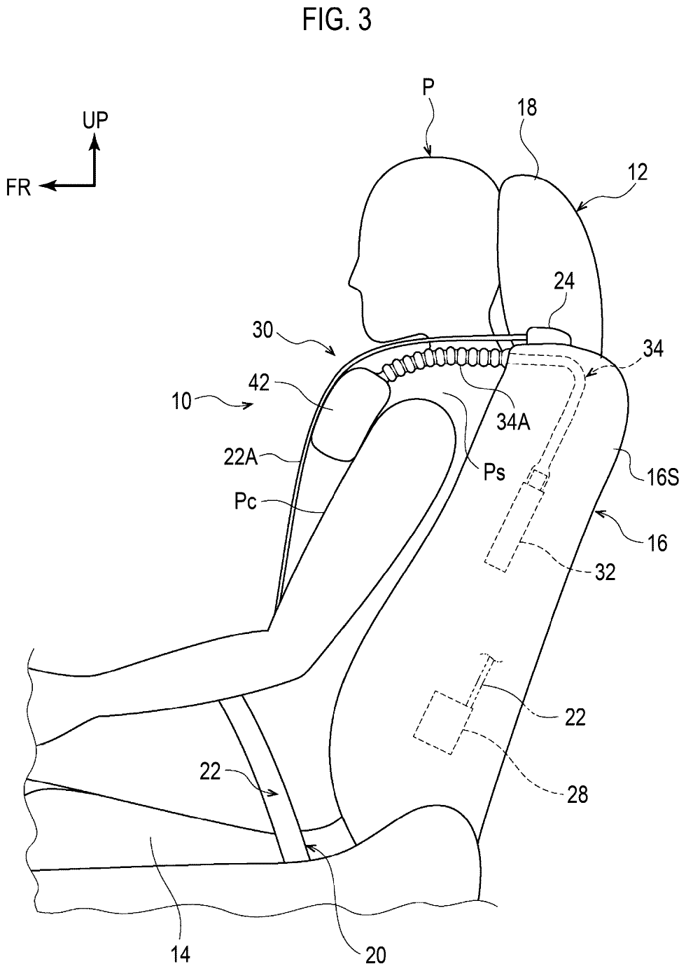

On an outer side in the vehicle width direction (first end portion side in the seat width direction) at an upper end surface of the seat back 16, a bezel 24 that serves as an outlet of a seat belt 22 is provided, and on an inner side in the vehicle width direction (second end portion side in the seat width direction) of the seat cushion 14, a buckle 26 for securing a tongue 25 provided on the seat belt 22 is provided (see FIG. 2). A retractor 28 for winding a first end portion side of the seat belt 22 is attached to a lower portion of a side frame (not shown) provided on the outer side in the vehicle width direction inside the seat back 16 (see FIG. 3). The retractor 28 is provided with a pretensioner mechanism and a force limiter mechanism.

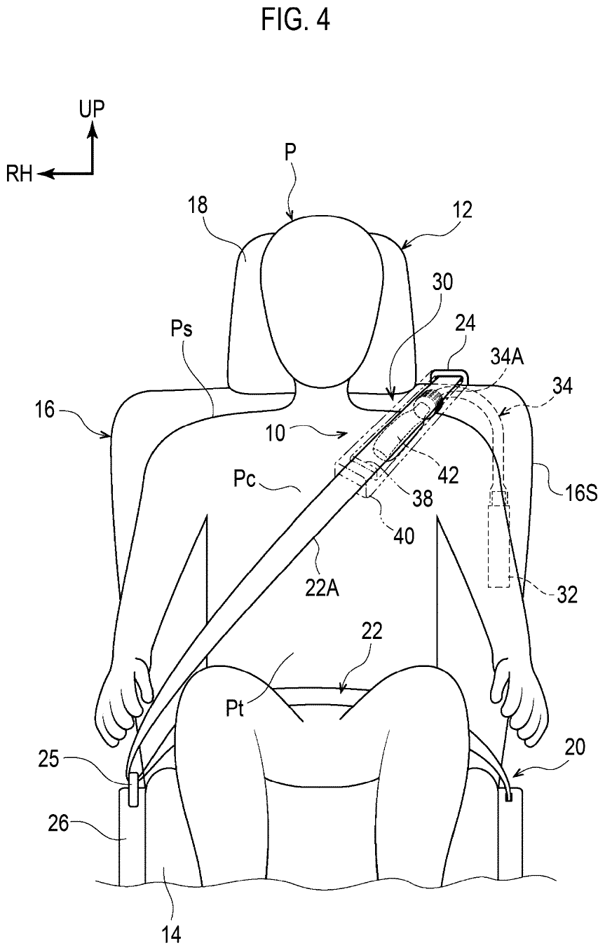

The vehicle seat 12 is provided with an airbag device 30. The airbag device 30 includes an inflator 32 embedded in a side portion 16S of the seat back 16 on the outer side in the vehicle width direction, a belt support airbag 42 accommodated in a cover member 40 (see FIGS. 4, 5, and 11A) in a folded state in a normal state, and a gas supply pipe 34 (described later) that connects the belt support airbag 42 and the inflator 32 and supplies gas from the inflator 32 to the belt support airbag 42.

As shown in FIGS. 4, 5, and 11A, the cover member 40 is attached by sewing or the like to a fabric holder member (not shown) that holds a guide member 38 through which the shoulder belt 22A is movably inserted. The cover member 40 covers the holder member, the folded belt support airbag 42 disposed on an occupant P side relative to the guide member 38, and an expandable portion 34A of the gas supply pipe 34, which will be described later, around the shoulder belt 22A facing the shoulder Ps of the occupant P.

The cover member 40 is configured to be broken at least on the occupant P side as the belt support airbag 42 inflates and deploys.

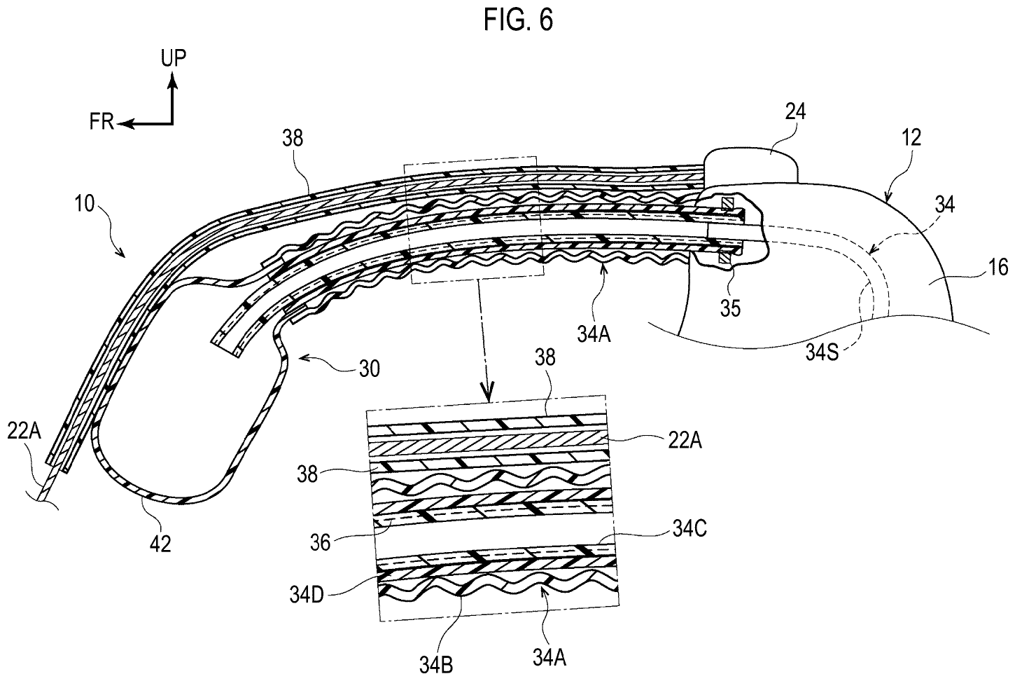

The guide member 38 is formed in a rectangular flat tubular shape, for example, of a silicone-based resin material with high slidability such that the shoulder belt 22A can easily move (slide) (see FIG. 10). The holder member is attached to a peripheral surface of the guide member 38 except for the occupant P side by any fixing member. As shown in FIGS. 6 and 10, the guide member 38 is configured to prevent the shoulder belt 22A from coming into contact with the expandable portion 34A of the gas supply pipe 34. Furthermore, the guide member 38 is configured to prevent an external force from being applied to the expandable portion 34A of the gas supply pipe 34 when the seat belt 22 is fastened or detached.

The inflator 32 is, for example, a gas-sealed (cold type) cylindrical inflator having a substantially cylindrical shape. The inflator is configured to generate gas by being activated by a control device (not shown) provided in the vehicle when a frontal collision of the vehicle is detected or a frontal collision is predicted (forecasted) to be unavoidable (hereinafter referred to as “in an event of a frontal collision of the vehicle”) by a collision sensor (not shown) including a camera or the like.

That is, the control device is electrically connected to the inflator 32 and the collision sensor, and is configured to activate the inflator 32 based on information from the collision sensor in an event of a frontal collision of the vehicle. A form of the frontal collision of the vehicle in which the control device activates the inflator 32 includes an offset frontal collision, such as an oblique collision or a small overlap collision, in addition to a full overlap frontal collision.

The inflator 32 is attached, for example, together with the retractor 28, to the side frame of the seat back 16 on the outer side in the vehicle width direction in a substantially up-down direction as an axial direction, and a first end portion of the cylindrical gas supply pipe 34 is communicatively connected to an ejection port, which is an upper end portion of the inflator 32. A second end portion of the gas supply pipe 34 protrudes from the seat back 16 on a side below the bezel 24 and is communicatively connected to the belt support airbag 42.

As shown in FIG. 6, the gas supply pipe 34 for supplying gas from the inflator 32 to the belt support airbag 42 is configured such that a part of the gas supply pipe 34 on a belt support airbag 42 side (second end portion side), that is, a predetermined region portion protruding from the seat back 16 serves as the expandable portion 34A configured to be extend following a forward movement of the belt support airbag 42.

Specifically, the gas supply pipe 34 is integrally configured by connecting a first end portion of the expandable portion 34A made of, for example, a heat-resistant elastomer resin to an upper end portion of a main body tube 34S made of resin or metal embedded in the seat back 16. The first end portion of the expandable portion 34A is fixed to the upper end portion of the main body tube 34S by a clamp member 35 or the like.

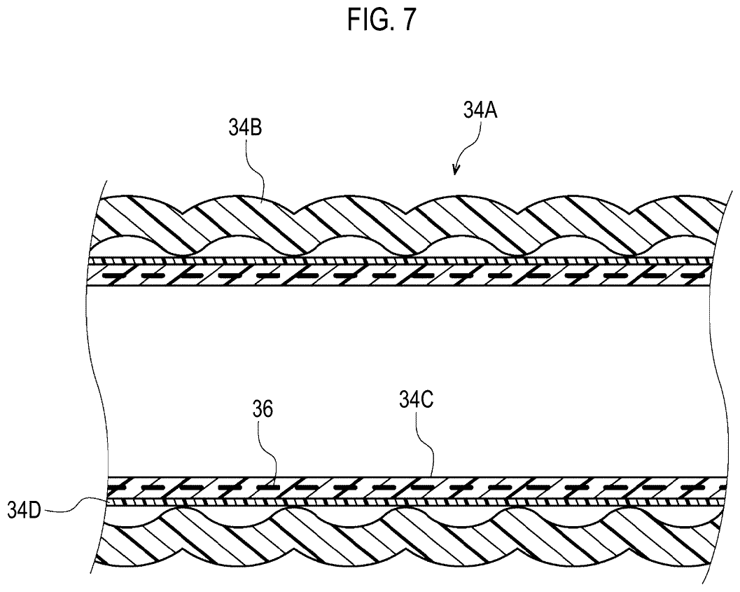

As shown in FIGS. 6 to 8B, the expandable portion 34A of the gas supply pipe 34 protruding from the seat back 16 is formed in a bellows shape and has a three-layer structure that is extendable by a predetermined tensile load. That is, the expandable portion 34A of the gas supply pipe 34 has an outer layer 34B formed in a bellows shape, an inner layer 34C in which a mesh-like metal stent member 36 capable of restricting excessive expansion is embedded, and a silicone coating layer 34D provided between the outer layer 34B and the inner layer 34C.

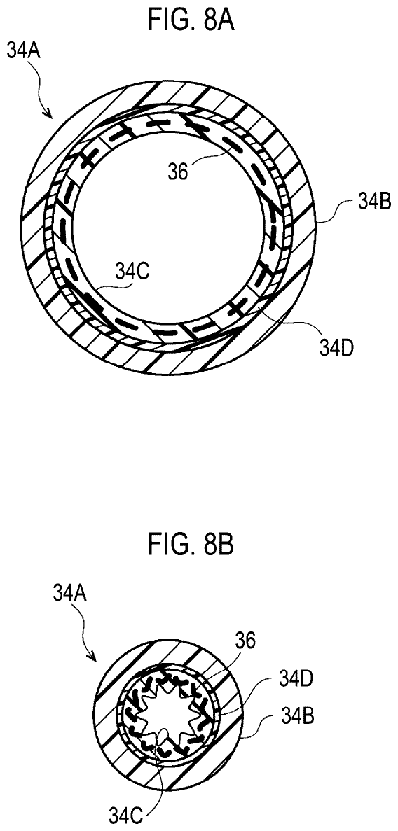

As a result, the expandable portion 34A of the gas supply pipe 34 is configured to extend and expand to a predetermined outer diameter when the gas is supplied and the belt support airbag 42 inflates and deploys. Specifically, the expandable portion 34A is configured such that bellows-shaped valley portions, which protrude radially inward and are reduced in inner diameter when shortened, expand due to deformation of a bellows knitted structure, whereby achieving rapid and sufficiently stable gas supply. The expandable portion 34A of the gas supply pipe 34 is configured to further extend and contract to a predetermined inner diameter when the belt support airbag 42 is moved forward as the occupant P moves forward (scc FIG. 8B).

That is, the gas supply pipe 34 also functions as a check valve by the contraction in diameter of the expandable portion 34A, so that the gas is difficult to return from an inside of the belt support airbag 42. The expandable portion 34A of the gas supply pipe 34 is configured to extend under a lower load than a force limiter load of the force limiter mechanism provided in the retractor 28. The stent member 36 is not limited to a metal material as long as the stent member 36 can withstand a tube expansion force during gas supply.

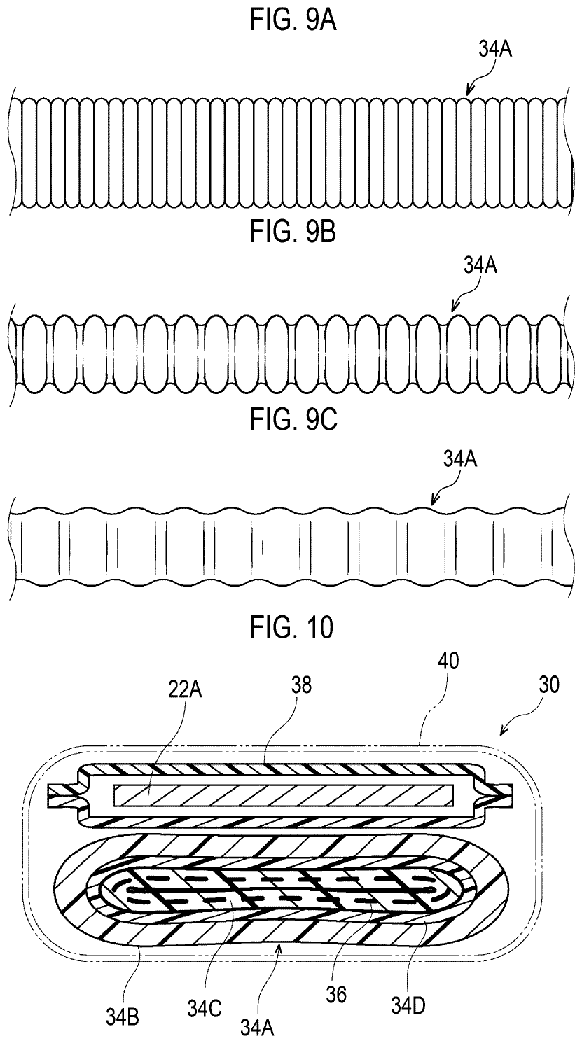

Furthermore, the expandable portion 34A of the gas supply pipe 34 is not limited to the configuration in which the stent member 36 is provided in the inner layer 34C. The expandable portion 34A of the gas supply pipe 34 may be configured as described above by being formed of an elastic body such as rubber, for example, as shown in FIGS. 9A to 9C. That is, the expandable portion 34A of the gas supply pipe 34 is configured to elastically deform to extend as shown in FIGS. 9B and 9C only when a tensile load is applied, and to be restored to an original state by an elastic restoring force as shown in FIG. 9A when no tensile load is applied.

With the expandable portion 34A of the gas supply pipe 34 having such a configuration, as in the case where the stent member 36 is provided, the expandable portion 34A can extend and expand to a predetermined outer diameter when the gas is supplied and the belt support airbag 42 inflates and deploys. Furthermore, when the belt support airbag 42 moves forward as the occupant P moves forward, the expandable portion 34A can further extend and contract to a predetermined inner diameter.

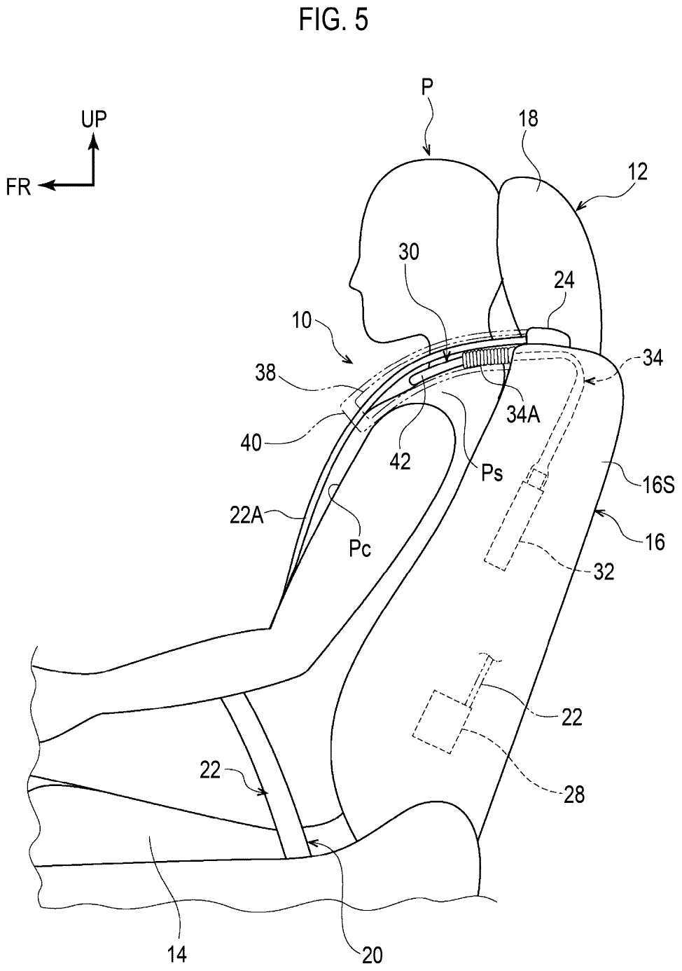

As shown in FIGS. 4 and 5, when the expandable portion 34A of the gas supply pipe 34 is accommodated in the cover member 40, the bellows-shaped portions of the expandable portion 34A are in a shortened state. Furthermore, as shown in FIG. 10, the expandable portion 34A may be formed in a crushed shape along an inner surface, which is on an occupant P side of the shoulder belt 22A. That is, both the expandable portion 34A of the gas supply pipe 34 having the crushed shape and the folded belt support airbag 42 may be accommodated in the cover member 40.

The belt support airbag 42 is formed in a bag shape by overlapping two sheets of base fabric in the front-rear direction, the two sheets having a substantially rectangular shape in a front view in which the seat width direction is a longitudinal direction, and sewing peripheral edge portions of the two sheets together. That is, as shown in FIGS. 1 to 3, the belt support airbag 42 after inflation and deployment is configured by a substantially cylindrical single chamber in which the seat width direction is the longitudinal direction (axial direction), and a length thereof in the axial direction is set to a length that can face the shoulder Ps of the occupant P in the front-rear direction. Each sheet of base fabric is formed of, for example, a polyamide-based or polyester-based fabric material.

The belt support airbag 42 is configured to be supplied with the gas from the inflator 32 through the gas supply pipe 34 passing through the side below the bezel 24. As a result, the belt support airbag 42 inflates and deploys to extend in the seat width direction at least between the shoulder belt 22A and both shoulders Ps of the occupant P, and moves forward following the occupant P, who moves forward due to an inertial force, in a form of being pushed by the occupant P, thereby restraining at least both shoulders Ps of the occupant P, including collarbones.

In the vehicle occupant restraint device 10 according to the first embodiment having the configuration, an operation thereof will be described below. In FIGS. 1 to 3, 11B, 12A, and 12B, the guide member 38 and the cover member 40 are not shown.

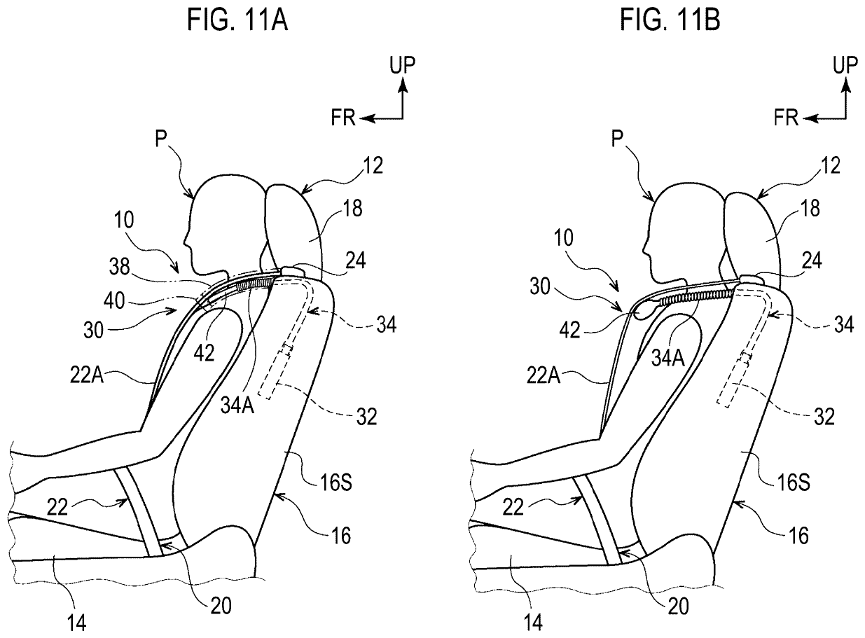

In an event of a frontal collision of the vehicle, the inflator 32 is activated by control of the control device. That is, the gas is ejected from the inflator 32. The gas ejected from the inflator 32 is then supplied into the belt support airbag 42 through the gas supply pipe 34. That is, as shown in FIG. 11B, the gas is supplied to the inside of the belt support airbag 42 in the folded state that is accommodated in the cover member 40 and is disposed on the occupant P side (back surface side) of the shoulder belt 22A.

Then, as shown in FIGS. 1 to 3 and 12A, the belt support airbag 42 inflates and deploys to extend in the seat width direction between the shoulder belt 22A and the shoulder Ps of the occupant P. As a result, the inflated and deployed belt support airbag 42 is disposed between the shoulder belt 22A and at least both shoulders Ps of the occupant P, including the collarbones, in other words, behind the shoulder belt 22A and in front of both shoulders Ps of the occupant P.

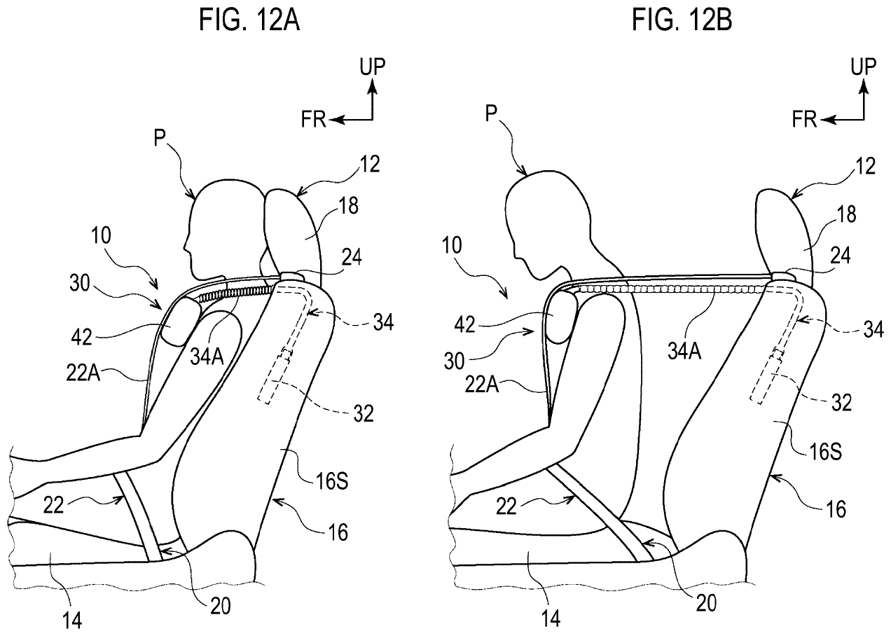

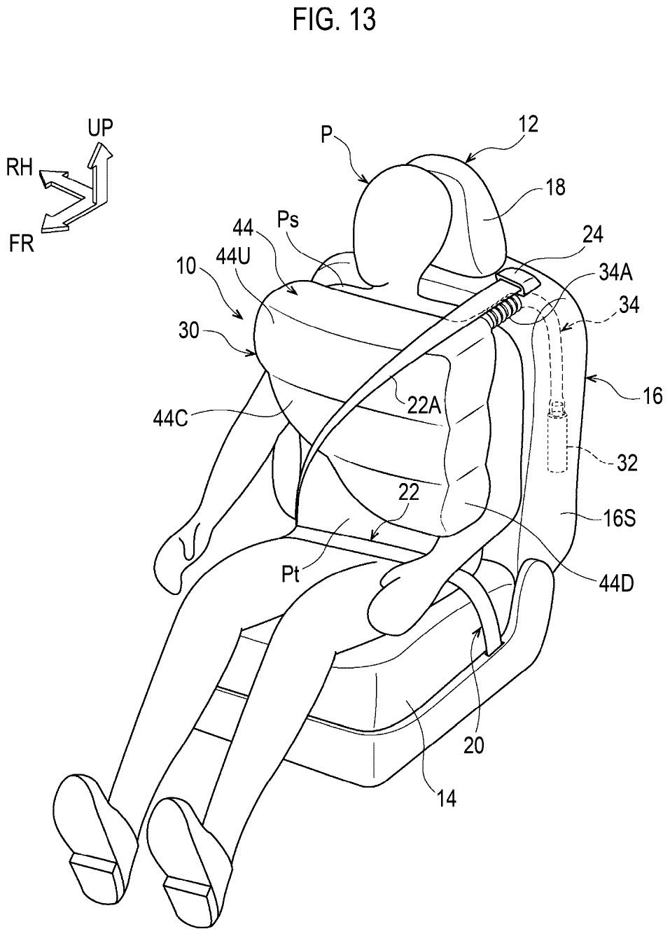

As shown in FIG. 12B, the belt support airbag 42 moves forward following the occupant P, who moves forward due to the inertial force caused by an impact in an event of a frontal collision of the vehicle, and restrains at least both shoulders Ps of the occupant P including the collarbones. That is, the shoulder belt 22A serves as a member that receives a reaction force of the belt support airbag 42.

At that time, the expandable portion 34A of the gas supply pipe 34 for supplying the gas from the inflator 32 to the belt support airbag 42 extends following the forward movement of the belt support airbag 42. Therefore, regardless of a physique of the occupant P, the belt support airbag 42 can be continuously held between the shoulder belt 22A and both shoulders Ps of the occupant P, and at least both shoulders Ps of the occupant P can be effectively restrained from a first half to a second half of the occupant restraint, while the occurrence of a problem, such as breakage (gas leakage) of the gas supply pipe 34, can be suppressed or prevented.

As described above, with the vehicle occupant restraint device 10 according to the first embodiment, even with a simple configuration in which the predetermined region portion of the gas supply pipe 34 on the belt support airbag 42 side serves as the bellows-shaped expandable portion 34A and is extendable following the forward movement of the occupant P, the occupant P can be efficiently restrained in an event of a frontal collision of the vehicle.

Furthermore, with the belt support airbag 42, an appropriate restraint force can be generated at an early stage for the shoulder Ps on a counter-shoulder belt side on which the shoulder belt 22A is not hung. In other words, a local load input from the shoulder belt 22A to the occupant P can be dispersed to both shoulders Ps through the belt support airbag 42 at an early stage. Therefore, even with the simple configuration, the input of the local load from the shoulder belt 22A to a chest Pc of the occupant P can be reduced, and both shoulders Ps of the occupant P can be efficiently restrained.

Furthermore, a thickness of the inflated and deployed belt support airbag 42 allows the shoulder belt 22A to be lifted from the chest Pc of the occupant P, and a predetermined gap can be formed between the shoulder belt 22A and the chest Pc of the occupant P. Therefore, the local load input from the shoulder belt 22A to the chest Pc of the occupant P can be reduced. As a result, a chest injury value caused by inhibition of forward movement due to the shoulder belt 22A can be reduced, particularly for occupants with relatively low chest resistance, such as a woman or an elderly person.

The expandable portion 34A of the gas supply pipe 34 is provided with the stent member 36 that restricts excessive expansion. Therefore, a decrease in gas supply capacity (gas pressure) due to the excessive expansion of the expandable portion 34A of the gas supply pipe 34 can be suppressed, and the expandable portion 34A can be prevented from being inflated and broken. Furthermore, excessive inflation of the expandable portion 34A of the gas supply pipe 34 near the head of the occupant P can also be suppressed or prevented.

The retractor 28 is provided with the force limiter mechanism. Here, the expandable portion 34A of the gas supply pipe 34 extends under a load lower than the force limiter load of the force limiter mechanism. Therefore, the occurrence of a problem in which the gas supply pipe 34 interferes with an operation of the force limiter mechanism can be suppressed or prevented. As a result, a behavior of the occupant P can be easily controlled.

In a normal state, the expandable portion 34A of the gas supply pipe 34 and the folded belt support airbag 42 are accommodated in the cover member 40 in a state of being disposed on an occupant P side of the guide member 38. That is, the expandable portion 34A of the gas supply pipe 34 and the folded belt support airbag 42 are provided outside the vehicle seat 12. Therefore, it is not necessary to provide a complicated structure inside the vehicle seat 12.

Additionally, the expandable portion 34A of the gas supply pipe 34 and the folded belt support airbag 42 are covered with the cover member 40 and hidden from the outside, so that an appearance of the vehicle seat 12 can be suppressed or prevented from being damaged. In particular, in a case where the cover member 40 is a design cover, the effect is further improved. In a normal state, the cover member 40 can avoid unnecessary contact with the expandable portion 34A of the gas supply pipe 34 or the folded belt support airbag 42, thereby ensuring durability.

Furthermore, when the expandable portion 34A of the gas supply pipe 34 is accommodated in the cover member 40, the bellows-shaped portion is shortened (see FIG. 5). Therefore, an accommodating space is reduced in size to the vicinity of the shoulder Ps of the occupant P, and accommodation performance is improved. Additionally, when the belt support airbag 42 inflates and deploys, the bellows-shaped portion of the expandable portion 34A of the gas supply pipe 34 extends and expands to a predetermined outer diameter. Therefore, the gas can be supplied to the belt support airbag 42 quickly, sufficiently, and stably. Furthermore, when the belt support airbag 42 moves forward, the bellows-shaped portion of the expandable portion 34A of the gas supply pipe 34 further extends and contracts to a predetermined inner diameter. Therefore, the gas supplied to the belt support airbag 42 is less likely to return to an inflator 32 side.

The expandable portion 34A of the gas supply pipe 34 may be accommodated in the cover member 40 in a crushed shape along the inner surface, which is on the occupant P side of the shoulder belt 22A (see FIG. 10). Accordingly, the expandable portion 34A of the gas supply pipe 34 can be utilized as a cushion member, so that wearability of a shoulder belt 22A part when the seat belt 22 is worn can be improved.

The shoulder belt 22A is movably inserted through the guide member 38 accommodated in the cover member 40, and is not in contact with the expandable portion 34A of the gas supply pipe 34. Therefore, when the seat belt 22 is fastened or detached, an external force, such as a tensile load, is not applied to the expandable portion 34A of the gas supply pipe 34, and the seat belt 22 can be smoothly moved. Furthermore, the guide member 38 can also prevent the seat belt 22 from being worn incorrectly in a twisted state.

The inflator 32 is embedded in the seat back 16 of the vehicle seat 12 together with the retractor 28. That is, each of components constituting the vehicle occupant restraint device 10, including the seat belt 22 and the like, are provided on the vehicle seat 12. Therefore, installation of each of the components constituting the vehicle occupant restraint device 10 can be completed solely by the vehicle seat 12. As a result, the vehicle occupant restraint device 10 can be easily installed in the vehicle by simply mounting the vehicle seat 12, and assembly workability during assembly of the vehicle can be improved.

### Second Embodiment

Next, a second embodiment will be described. The same reference numerals are given to the same parts as those in the first embodiment, and detailed description (including common actions) will be omitted as appropriate.

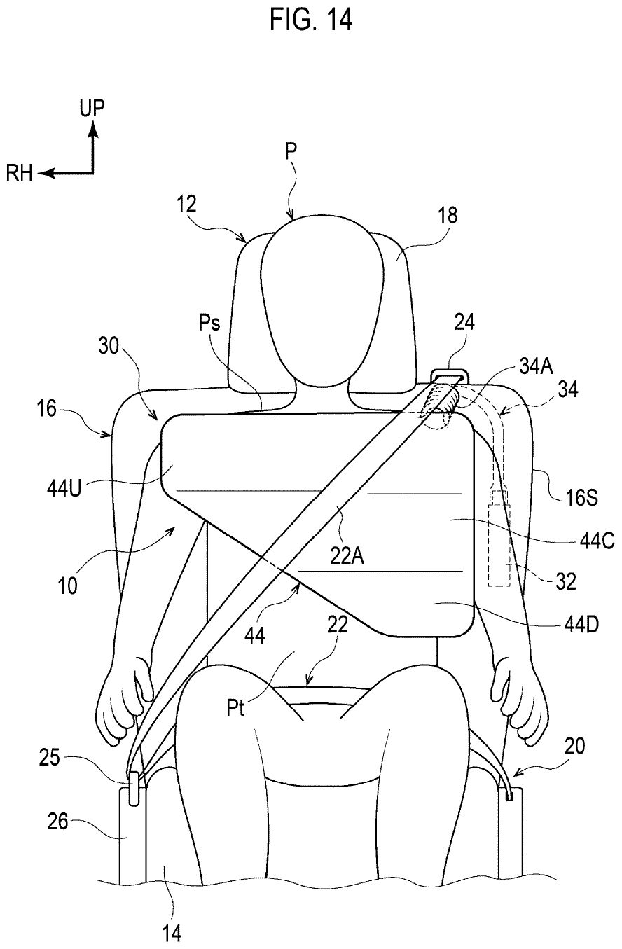

As shown in FIGS. 13 to 15, in the second embodiment, solely the shape of the belt support airbag is different from the first embodiment. That is, a belt support airbag 44 is formed in a bag shape by overlapping two sheets of base fabric in the front-rear direction, the two sheets having a substantially rectangular shape in a front view, and sewing peripheral edge portions of the two sheets together, and a shape of the belt support airbag 44 after inflation and deployment is completed is a substantially right-angled triangular shape in a front view, in which a buckle 26 side forms a hypotenuse. Each sheet of base fabric is formed of, for example, a polyamide-based or polyester-based fabric material.

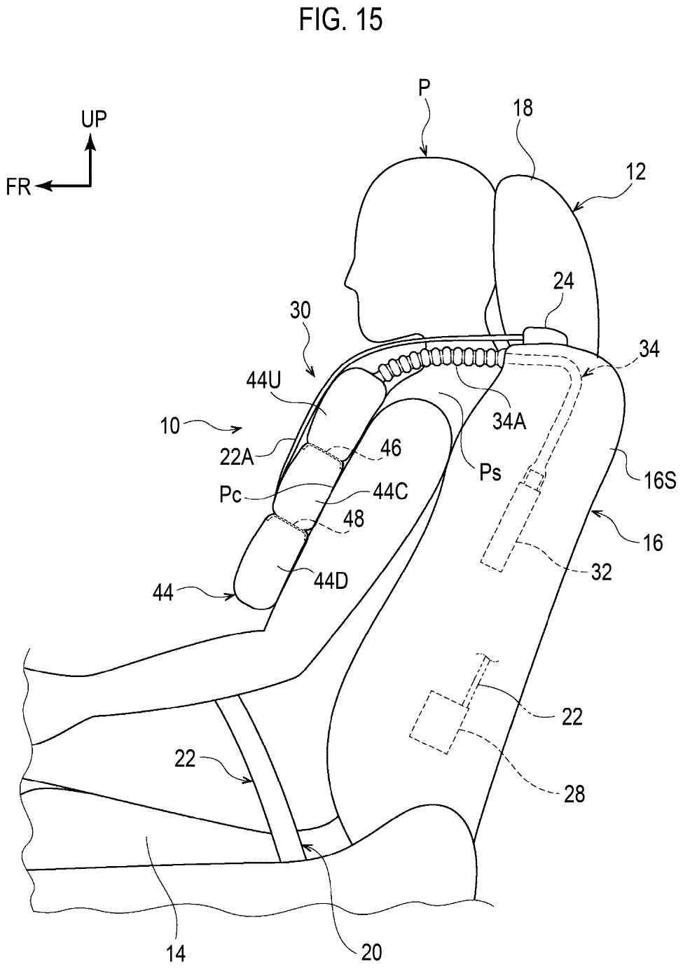

The belt support airbag 44 is partitioned into a plurality of chambers (for example, three stages) extending along the seat width direction by a plurality of (for example, two) tethers 46, 48 (see FIG. 15) provided inside the belt support airbag 44. Specifically, the two fabric-like tethers 46, 48 in which the seat width direction is a longitudinal direction are attached to an inside of the belt support airbag 44 at an interval therebetween in the up-down direction. The tethers 46, 48 are also formed of, for example, a polyamide-based or polyester-based fabric material.

An opening (not shown) is formed in an outer portion of the tether 46 in the vehicle width direction, and the gas can be supplied from an upper chamber 44U partitioned by the tether 46 to a middle chamber 44C. Similarly, an opening (not shown) is formed in an outer portion of the tether 48 in the vehicle-width direction, and the gas can be supplied from the middle chamber 44C partitioned by the tether 48 to a lower chamber 44D. The upper chamber 44U and the middle chamber 44C are each provided with a check valve structure (not shown) for holding an internal pressure.

With the belt support airbag 44 having such a configuration, when the gas is supplied from the inflator 32 through the gas supply pipe 34, the gas is first supplied to the upper chamber 44U, and the upper chamber 44U inflates and deploys. Then, when the inflated and deployed upper chamber 44U is sealed by the check valve structure, the gas is supplied to the middle chamber 44C through the opening of the upper tether 46, and the middle chamber 44C inflates and deploys. Thereafter, when the inflated and deployed middle chamber 44C is sealed by the check valve structure, the gas is supplied to the lower chamber 44D through the opening of the lower tether 48, and the lower chamber 44D inflates and deploys.

As a result, the belt support airbag 44 is sequentially supplied with the gas from the upper chamber 44U to the lower chamber 44D through the middle chamber 44C, and is disposed to inflate and deploy at least between the shoulder belt 22A and the chest Pc of the occupant P, in other words, behind the shoulder belt 22A and in front of the occupant P. The inflated and deployed belt support airbag 44 moves forward following the occupant P, who moves forward due to an inertial force caused by an impact in an event of a frontal collision of the vehicle, and restrains at least the chest Pc of the occupant P. That is, also in this case, the shoulder belt 22A serves as a member that receives a reaction force of the belt support airbag 44.

With the belt support airbag 44 having such a configuration, a local load applied to the chest Pc of the occupant P by the shoulder belt 22A is distributed over a wide range of the chest Pc of the occupant P and reduced. Therefore, a chest injury value caused by inhibition of forward movement due to the shoulder belt 22A can be reduced, particularly for occupants with relatively low chest resistance, such as a woman or an elderly person.

Furthermore, with the belt support airbag 44, for example, even in a case where the occupant P seated on the vehicle seat 12, for example, in a driver seat or a passenger seat during autonomous driving, takes a seat position that is far rearward from a steering wheel (not shown) or from a frontal collision airbag (not shown) that inflates and deploys toward a front of the occupant P, the occupant P can be effectively restrained. That is, with the belt support airbag 44, the occupant P can be effectively restrained regardless of the seat position of the vehicle seat 12 in an event of a frontal collision of the vehicle.

In the belt support airbag 44, the upper chamber 44U inflates and deploys first. Therefore, a position of the shoulder belt 22A can be stabilized, and a predetermined gap between the shoulder belt 22A and the occupant P can be efficiently formed. As a result, the inflation and deployment of each chamber, from the upper chamber 44U through the middle chamber 44C to the lower chamber 44D, can be smoothly performed.

Although the vehicle occupant restraint device 10 according to the present embodiment has been described based on the drawings, the vehicle occupant restraint device 10 according to the present embodiment is not limited to the illustrated example, and can be appropriately modified in design within the scope that does not depart from the gist of the present disclosure. For example, the second end portion of the gas supply pipe 34 may be configured to protrude through the bezel 24.

The expandable portion 34A of the gas supply pipe 34 is not limited to the layers (three layers), and may be configured as, for example, a single layer. The expandable portion 34A of the gas supply pipe 34 is not limited to being formed in a bellows shape. For example, the outer layer 34B included in the expandable portion 34A of the gas supply pipe 34 may be formed of knitted fibers as long as the outer layer 34B has sufficient extension characteristics or an effect of suppressing excessive expansion.

The cover member 40 may accommodate at least the expandable portion 34A of the gas supply pipe 34 and the folded belt support airbag 42, and for example, a lower end portion of the guide member 38 may protrude from the cover member 40. In the present embodiment, even in such a case, the guide member 38 is accommodated in the cover member 40.

The belt support airbags 42, 44 are not limited to the configuration in which two sheets of base fabric are overlapped and the peripheral edge portions are sewn, and may have a configuration in which three or more sheets of base fabric are used and peripheral edge portions thereof are sewn. The material of the guide member 38 is not limited to the silicone-based resin material with high slidability, and other materials with desirable slidability can also be applied.

What is claimed is:

1. A vehicle occupant restraint device comprising:
a seat belt configured to restrain an occupant seated on a vehicle seat to the vehicle seat;
a belt support airbag configured to inflate and deploy at least between a shoulder belt in the seat belt and a shoulder of the occupant by being supplied with gas from an inflator in an event of a frontal collision of a vehicle, to move toward a front side of the vehicle following the occupant, who moves toward the front side of the vehicle due to an inertial force, and to restrain at least the shoulder of the occupant; and
a gas supply pipe having a first end portion connected to the inflator and a second end portion connected to the belt support airbag,
wherein a predetermined region of the gas supply pipe on a second end portion side is configured to extend following movement of the belt support airbag toward the front side of the vehicle.

2. The vehicle occupant restraint device according to claim 1, further comprising a cover member, wherein:
a bellows-shaped expandable portion is provided in the predetermined region of the gas supply pipe; and
the expandable portion of the gas supply pipe and the belt support airbag that is folded are accommodated in the cover member.

3. The vehicle occupant restraint device according to claim 2, wherein:
the bellows-shaped expandable portion is configured to be shortened when the bellows-shaped expandable portion is accommodated in the cover member;
the bellows-shaped expandable portion is configured to extend and expand to a predetermined outer diameter when the belt support airbag inflates and deploys; and
the bellows-shaped expandable portion is configured to further extend and contract to a predetermined inner diameter when the belt support airbag moves toward the front side of the vehicle.

4. The vehicle occupant restraint device according to claim 3, wherein the expandable portion of the gas supply pipe is provided with a stent member that restricts excessive expansion.

5. The vehicle occupant restraint device according to claim 2, wherein the expandable portion of the gas supply pipe is formed in a crushed shape along the shoulder belt when the expandable portion is accommodated in the cover member.

6. The vehicle occupant restraint device according to claim 2, wherein the shoulder belt is movably inserted through a guide member accommodated in the cover member and is not in contact with the expandable portion of the gas supply pipe.

7. The vehicle occupant restraint device according to claim 2, wherein:
a force limiter mechanism is provided in a retractor that winds the seat belt; and
the expandable portion of the gas supply pipe is configured to extend under a load lower than a force limiter load of the force limiter mechanism.

8. The vehicle occupant restraint device according to claim 7, wherein the inflator is embedded in a seat back of the vehicle seat together with the retractor.

9. The vehicle occupant restraint device according to claim 1, wherein:
a bellows-shaped expandable portion is provided in the predetermined region of the gas supply pipe; and
the expandable portion is provided between a seat back and the belt support airbag.
